(19) United States
(12) Patent Application Publication
(10) Pub. No.: US 2012/0203411 A1
(43) Pub. Date: Aug. 9, 2012

(54) Method and Device for Adapting and/or Diagnosing an Internal Combustion Engine Situated in a Hybrid Vehicle

(76) Inventors: Georg Mallebrein, Korntal-Muenchingen (DE); Andreas Bethmann, Leonberg (DE)

(21) Appl. No.: 13/389,653

(22) PCT Filed: Jul. 14, 2010
(86) PCT No.: PCT/EP10/60129

§ 371 Date: Apr. 23, 2012

(30) Foreign Application Priority Data
Aug. 10, 2009 (DE) 10 2009 028 374.9

(51) Int. Cl. B60W 50/04; B60W 20/00

(52) U.S. Cl. 701/22; 903/902; 180/65.265

(57) ABSTRACT

In a method for adapting and/or diagnosing an internal combustion engine which is situated in a hybrid vehicle and forms a drive unit with at least one secondary machine, a positive or negative drive torque is applied to the internal combustion engine by the secondary machine for setting various operating states of the internal combustion engine, and at least one operating parameter of the internal combustion engine is determined at a set operating point.

### BACKGROUND OF THE INVENTION

1. Field of the Invention

The present invention relates to a device and method for adapting and/or diagnosing an internal combustion engine, which is situated in a hybrid vehicle and forms a drive unit with at least one secondary machine.

2. Description of Related Art

Vehicles having a hybrid drive structure have an internal combustion engine and a secondary machine, mostly an electric motor. Therefore, the drive torque may be applied by both drive units during driving operation of the hybrid vehicle. The internal combustion engine is mechanically coupled to the secondary machine in such a hybrid vehicle. This coupling is achieved either directly or via a transmission. The secondary machine designed as an electric motor may be operated either as a motor or as a generator. A high-voltage battery, which is discharged during use of the electric motor as a power train drive or is charged during generator operation, is available as the energy storage.

Diagnosis or adaptation of an internal combustion engine in a hybrid vehicle is currently limited in that only certain load conditions of the internal combustion engine may be determined on a test stand. Moreover, certain operating points are only able to be reached in test runs resulting in long diagnostic times.

### BRIEF SUMMARY OF THE INVENTION

The method according to the present invention for adapting and/or diagnosing an internal combustion engine situated in a hybrid vehicle has the advantage that the internal combustion engine may be adapted and/or diagnosed more quickly and easily. As a result of a positive or negative drive torque being applied to the internal combustion engine by the secondary machine for setting different operating states of the internal combustion engine and at least one operating parameter of the internal combustion engine being determined at a set operating point, it is possible to significantly reduce the diagnostic effort, especially in the workshop environment. In general, the method according to the present invention may be implemented in all hybrid vehicles in which the internal combustion engine is driven by one or more secondary machines regardless of the vehicle speed. In this context a positive drive torque refers to a contribution of the secondary machine in addition to the drive torque of the internal combustion engine for propelling the vehicle, while a negative drive torque is a braking torque generated by the secondary machine in opposition to the drive torque of the internal combustion engine.

A series of new diagnostic methods may be implemented by adding a known load (braking torque) or a known drive torque.

The secondary machine, which applies a negative drive torque to the independently running internal combustion engine, is advantageously designed as an electric motor. In this context the electric motor functions as a generator and loads the internal combustion engine with an additional braking torque. The internal combustion engine thus works under an increased load and is in a state in which it supplies energy via the combustion of fuel which is converted into a drive movement of the hybrid vehicle. In the case of such a higher load on the internal combustion engine, it is operated at higher air mass flows, which are used for adaptation and/or diagnosis purposes.

In one embodiment, the adaptation and/or diagnosis is performed at high loads on the internal combustion engine during stationary operation of the hybrid vehicle in which the drive unit is decoupled from a drivetrain of the hybrid vehicle. Since this operating state of the internal combustion engine is set without moving the vehicle, time-intensive test runs are not necessary, thus shortening the diagnosis or adaptation times.

In one refinement, the adaptation and/or diagnosis is/are performed during driving of the hybrid vehicle in that the electric motor shifts the operating point of the internal combustion engine to higher loads by applying a negative drive torque in the case of an unchanged driver request torque. As a result, the operating point of the internal combustion engine may briefly deviate from the optimum operating point predefined by the driver during driving operation to allow or to improve a diagnosis. This takes place while maintaining the request torque set by the driver so that the driver does not notice any effects of the diagnosis.

Moreover, different load points are approached by the electric motor as operating points of the internal combustion engine during stationary operation of the hybrid vehicle, in particular on a test stand in a workshop, a driving operation state stored in the vehicle being retraced at every load point and an onboard diagnosis of the hybrid vehicle as typically occurs during vehicle operation being run through. To verify error entries that occurred during the driving operation and were stored, the diagnoses created during the driving operation are repeated in the workshop to obtain a more precise indication of any error sources. However, the method is also suitable for a quick check to determine whether a repair at the workshop was successful.

An exact operating window for a mixture and air charge adaptation is advantageously set at the particular load points at a higher load. In contrast to today's options in which only ranges near idling may be diagnosed, adaptation ranges are differentiated more precisely and operating points at a higher load are also approached and tested.

In one embodiment, at least one misfire rate of a cylinder of the internal combustion engine is determined at the individual load points at a higher load. Misfire errors are able to be reproduced at any time by precisely approaching the load points used as operating points.

In one refinement, the electric motor runs through its entire torque characteristic curve plotted against the speed, an ignition error being inferred in the case of a decreasing misfire rate determined over the load of the internal combustion engine, while a fuel injection error is assumed in the case of a constant misfire rate over the load. Thus, the actual error may be inferred after the desired operating state is established on the basis of the frequency of misfires with the aid of an additional error measurement technique. This is a diagnosis option previously not available with this level of simplicity.

In another embodiment, the speed of the electric motor is increased for leakage testing of a turbocharger system of the drive unit as long as the drive torque of the electric motor is greater than the drive torque of the internal combustion engine driven by the electric motor, a supercharging pressure characteristic curve recorded during the speed increase being compared to a setpoint characteristic curve. In the case of a deviation of the recorded supercharging pressure characteristic curve from the setpoint characteristic curve, leakage of the turbo system or an error in the turbine is inferred which is very easy to establish using the present method. A turbocharger is used to increase the performance of the internal combustion engine designed as a piston engine by increasing the mixture flow rate (fuel/air flow rate) per combustion cycle which is achieved by a compressor in the intake tract. The compressor is driven by an exhaust-gas turbine, which uses the energy of the exhaust gases.

Different speeds of the internal combustion engine are advantageously set by the electric motor as operating points for an air system diagnosis with an open throttle valve and a measured or calculated air mass flow is compared to an expected air mass flow. On the basis of this simple method, statements regarding the operating state of the air system may be made via an individual sensor, in particular a hot film air mass meter. However, the air mass flow may also be calculated from the intake manifold pressure with reference to the measurement results of two pressure sensors. The measured or calculated air mass flow may be improved when a correction factor is included that takes the ambient pressure and the intake temperature into account.

In one refinement, the secondary machine designed as an electric motor alternately adds a positive and a negative drive torque to the internal combustion engine. Taking advantage of the fact that the torques of the electric motor are effectively measurable at any time and are reproducible, new adaptation and/or diagnosis methods are applicable.

In one embodiment, an actual relative air mass in the cylinders of the internal combustion engine is determined at a set operating point of the internal combustion engine, preferably the speed, and is compared to a predefined relative air mass, the actual relative air mass being corrected by an air charge correction factor, thus resulting in the actual relative air mass having only a fuel error component. This has the advantage that an air mass error may be differentiated from a fuel error in the measurement result in a simple manner, resulting in a significantly more precise analysis.

In this context, the electric motor applies a positive drive torque to the internal combustion engine that does not generate its own drive torque, the positive drive torque of the electric motor being measured, and then a negative drive torque, which is also measured, is applied at the same operating point of the internal combustion engine to the independently running internal combustion engine by the electric motor, the drive torque executed by the internal combustion engine being ascertained from the measured negative drive torque and the measured positive drive torque of the electric motor from which the actual relative air mass is determined with the aid of a characteristic map. The exact measurement of the torques of the electric motor makes it possible to precisely reproduce the measurement results at any time via targeted setting of the operating point which allows implementation of such a diagnosis.

New adaptation methods and/or diagnoses are advantageously permitted when the secondary machine designed as an electric motor applies a positive drive torque to the internal combustion engine that does not generate its own drive torque. The internal combustion engine is only cranked mechanically by the electric motor, which is referred to as drag operation mode, and does not generate its own drive torque due to the lack of ignitions.

One embodiment provides a new diagnosis method for a compression test of the cylinders of the internal combustion engine, the electric motor only cranking the internal combustion engine mechanically, the air in the cylinders being compressed without an injection of a fuel and a signal of a crankshaft moved by the cylinders being measured, an error being inferred in the case of a slightly fluctuating crankshaft signal or in the case of a lower compression torque to be generated by the electric motor, while the compression of the cylinders is considered error-free in the case of a significantly fluctuating crankshaft signal. This diagnosis is possible since the electric motor, in contrast to the otherwise typical starter, is not able to set any fast speeds but only very low speeds. Operating ranges of the internal combustion engine that were previously not accessible for adaptation and/or diagnosis purposes are set as a result.

A compression test makes such a diagnosis of a cylinder shut-off possible since deactivated cylinders also have a compression in the charge cycle at the upper dead center of the cylinder. This compression may be ascertained via the speed of the electric motor or an evaluation of the compression torque of the electric motor.

The positive drive torque applied by the electric motor to the internal combustion engine during a supercharging pressure test is advantageously increased via the speed of the electric motor, the supercharging pressure characteristic curve of the turbo system of the internal combustion engine being recorded and compared to the predefined setpoint characteristic curve. In the case of a dragged turbo motor, the supercharging pressure curve is analyzed, for example, plotted against the speed, and leaks in hoses or in the bypass valve in the exhaust-gas flow are diagnosed. An own setpoint supercharging pressure characteristic curve must be stored for this diagnosis since the exhaust-gas enthalpy is missing in contrast to the independent operation of the internal combustion engine. Since no combustion noises occur, this test method is significantly quieter than previously known methods.

In another specific embodiment, the electric motor at a constant low speed applies the positive drive torque to the internal combustion engine for a measurement of the air mass flow rate in an exhaust-gas recirculation, an exhaust-gas recirculation valve being opened incrementally with the throttle valve almost closed and the air mass flow rate in the intake manifold situated downstream from the throttle valve being evaluated. The measurement may be performed without a subsequent correction of the measurement results due to the elimination of a limitation due to combustible exhaust gases and corresponding temperature tolerances. This diagnosis may be repeated at any time with reproducible measurement results.

In one refinement, the electric motor at a continuously changing speed transfers the positive drive torque to the internal combustion engine for diagnosing the air system with the open throttle valve and the expected air mass flow is compared to the measured or calculated air mass flow. Since there is no combustion in the internal combustion engine, the falsifying of the measurement results by temperature influences is negligible. Moreover, this measurement method is very quiet since it is carried out while the internal combustion engine is not ignited. Moreover, the measurement method may be performed in a targeted manner with a fully open throttle valve, a situation that usually does not occur during driving operation of the vehicle, particularly at low speeds.

A friction torque diagnosis of at least one cylinder of the internal combustion engine is advantageously performed in that the positive drive torque, which is transferred by the electric motor to the internal combustion engine, is measured and an excessive friction torque in the cylinder of the internal combustion engine is inferred when a predefined positive drive torque is exceeded. Therefore, jamming of a piston in the cylinder of the internal combustion engine may be detected promptly. A diagnosis of the drive output of ancillary units, such as torque sensing of the air conditioning system or the generator, is also possible.

Another refinement of the present invention relates to a device for adapting and/or diagnosing an internal combustion engine, which is situated in a hybrid vehicle and forms a drive unit together with a secondary machine.

To facilitate a faster and simpler adaptation and/or diagnosis method for the internal combustion engine, means are provided which set different operating states of the internal combustion engine in that a positive or negative drive torque is applied to the internal combustion engine by the secondary motor and at least one operating parameter of the internal combustion engine is determined at a predefined operating point. As a result, a significant reduction of the diagnosis effort is achieved, especially in the workshop environment, since previously known diagnoses may be performed more quickly by eliminating previously necessary test runs. Moreover, new diagnosis methods may be introduced due to the variable setting of the operating states of the internal combustion engine. An exact reproduction of measurement results is possible at any time by a targeted setting of the operating point of the internal combustion engine. In particular in the case of diagnoses for higher loads, a diagnosis of the fuel supply system for differentiating between additive and multiplicative tolerances is possible.

### BRIEF DESCRIPTION OF THE DRAWINGS

FIG. 1 shows a schematic view of a vehicle having a hybrid drive.

### DETAILED DESCRIPTION OF THE INVENTION

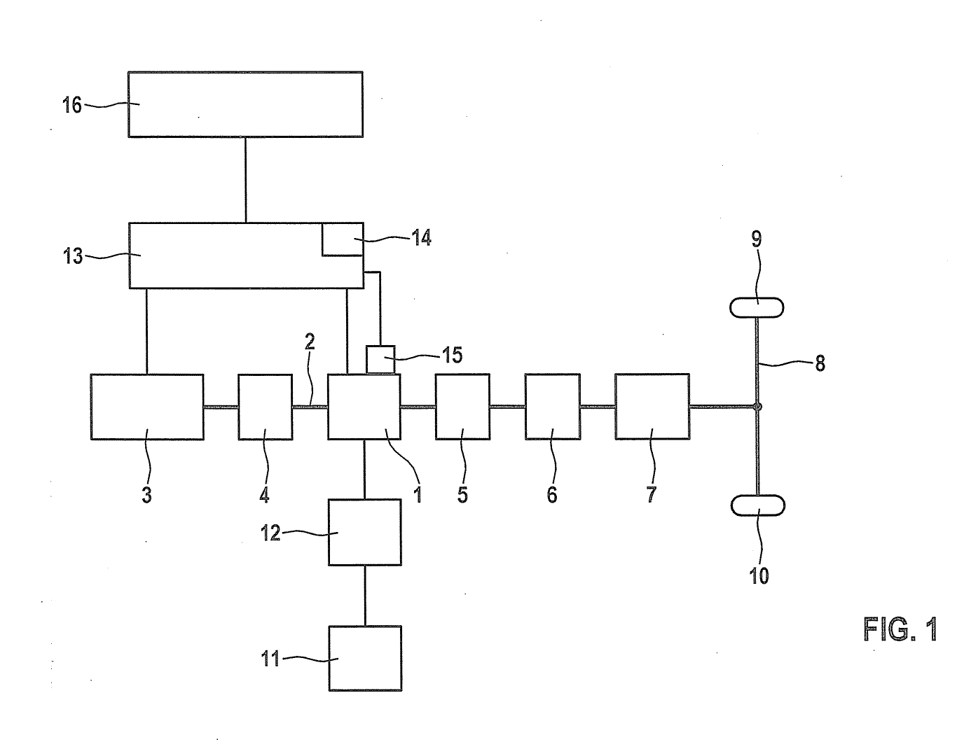

FIG. 1 shows a hybrid vehicle designed as a parallel hybrid. In this embodiment an electric motor 1 is situated on drive shaft 2 of an internal combustion engine 3. Internal combustion engine 3 is connected to electric motor 1 via a separating clutch 4. Electric motor 1 is connected via a starting clutch 5 to a torque converter 6, which is connected to a transmission 7. Transmission 7 is connected to an axle 8 on which wheels 9, 10, which are driven by the described drivetrain, are situated.

Electric motor 1 is supplied with energy by a high-voltage battery 11, which is connected to electric motor 1 via an inverter 12. Electric motor 1 and internal combustion engine 3 are controlled by a control unit 13. Control unit 13 includes a memory 14, in which characteristic curves for different operating parameters and current operating parameters for further processing are stored. For this purpose, control unit 13 is connected to a plurality of sensors not shown in greater detail. A current sensor 15 is situated at the electric motor to determine the positive or negative drive torque of electric motor 1, the current sensor measuring at every operating state the current consumption of electric motor 1, which is supplied to control unit 13 for the calculation of the drive torque.

To check internal combustion engine 3 for possible error situations, diagnoses or adaptations are performed either in the workshop or during driving operation. A check is performed during a diagnosis to determine whether a predefined operating parameter is actually set by internal combustion engine 3, while long-term monitoring of individual operating parameters is performed during an adaptation and a tendency of the monitored operating parameter and thus an error characteristic are ascertained.

Electric motor 1 connected via separating clutch 4 to internal combustion engine 3 is used for adapting and/or diagnosing internal combustion engine 3, separating clutch 4 being engaged. In the following, it is assumed that the vehicle is on a test stand in a workshop. To suppress driving operation of the hybrid vehicle, starting clutch 5 is disengaged, thus disconnecting internal combustion engine 3 and electric motor 1 from drivetrain 6, 7, 8, 9, 10 of the hybrid vehicle. A diagnosis control unit 16, which causes control unit 13 to activate internal combustion engine 3 and electric motor 1 in various operating states, is connected to control unit 13.

In a first operating state, internal combustion engine 1 is ignited, causing the internal combustion engine to independently generate a drive torque. Electric motor 1 is operated as a generator, electric motor 1 generating a drive torque opposite to the drive torque generated by internal combustion engine 3 and thus braking internal combustion engine 3. As a result, a load is applied to internal combustion engine 3 and engine operation at higher air mass flows is possible. Thus, it is possible to make diagnoses at higher loads and speeds of internal combustion engine 1 without moving the vehicle.

Via such a generator load addition by electric motor 1, different operating points of internal combustion engine 3 are approached and the misfire rate of the cylinders of internal combustion engine 3 is detected as a function of the operating point. For this purpose, control unit 13 activates electric motor 1 in such a way that it runs through its torque characteristic curve over its entire speed range, the misfire rate of internal combustion engine 3 braked by electric motor 1 being measured. If the misfire rate decreases when plotted against the speed of electric motor 1, it is determined that internal combustion engine 3 has an ignition problem. This determination is based in particular on the fact that the ignition voltage requirement increases as the load increases. If almost identical misfire rates occur when plotted against the speed of electric motor 1 at an increasing load, a problem regarding the supply of fuel and/or air mass is assumed.

In another case diagnosis control unit 16 initiates a second operating state in which electric motor 1 alternately applies a positive drive torque and a negative drive torque to internal combustion engine 3. This means that electric motor 1 is used as both a drive motor and a generator.

In this operating state, a diagnosis may be performed in a particularly simple manner with the aid of which an air mass error may be differentiated from a fuel error. For this purpose, the torque of electric motor 1, which makes it possible to make a statement about which torque must be expended to crank internal combustion engine 3, is measured in a first step in which internal combustion engine 3 is not ignited and therefore is only mechanically driven, i.e., dragged, by electric motor 1, which functions at a predefined speed.

In a second step, internal combustion engine 3 is started. Ignitions that initiate movement of the cylinders of internal combustion engine 3 and the crankshaft connected thereto occur, resulting in the generation of a positive drive torque by internal combustion engine 3. The following basic conditions are necessary for the operating point of internal combustion engine 3 to be set: Fixed speed of electric motor 1, constant intake manifold pressure of internal combustion engine 1, lambda efficiency is set to 1, and the ignition angle efficiency is presumed to be optimal. The torque measurement of electric motor 1 is performed via the current consumption of sensor 15.

Electric motor 1 acts on this state of internal combustion engine 3 as a braking machine in that it applies a negative drive torque to internal combustion engine 3. Electric motor 1 is at the same speed as in the first step. The negative drive torque of electric motor 1 is also measured here.

To determine the torque indicated by internal combustion engine 3, the difference is formed from the negative drive torque of electric motor 1 determined in the second step and the positive drag torque of electric motor 1 measured in the first step. Based on this indicated torque of the internal combustion engine, an expected relative air mass is determined from a characteristic curve which is compared to the actual relative air mass which is determined, for example, with the aid of a hot film air mass meter. The difference between the expected air mass and the actual relative air mass is arithmetically corrected with the aid of an air charge correction factor in the mixture determination so that only a fuel error component remains in the mixture determination.

In a third operating state, electric motor 1 is used as a motor and consequently applies a positive drive torque to internal combustion engine 3. Electric motor 1 drags the internal combustion engine without internal combustion engine 3 itself generating a positive drive torque via combustion. In this operating state, the cylinders of internal combustion engine 3 are easily able to be checked for leaks. For this purpose electric motor 1 applies a torque to internal combustion engine 3 that only results in cranking of internal combustion engine 3 at very low speeds. This means that the cylinder pistons move slower in the case of a leak. In the case of poor compression, the compression torque of the electric motor, but primarily the returned expansion torque, decreases. This results in an electric motor load that is greater on average when the compression performance is reduced.

With the elimination of the injection, only the air mass is compressed during this diagnosis. A time window including the movement of the piston of a cylinder against the upper dead center of the cylinder in which ignition of internal combustion engine 3 normally occurs in the case of a filling with fuel is taken into consideration. The torque generated by internal combustion engine 3 is measured via this time window in that a signal is picked off at the crankshaft of internal combustion engine 3. If the torque is constant across the time window, i.e., if the engine is running smoothly, an error is inferred. If the directly measured torque of internal combustion engine 3 fluctuates within the time window during compression, i.e., if it is greater in one time window or smaller in another time window, it is inferred that there are no leaks in internal combustion engine 3.

The method according to the present invention may be used in parallel hybrids as well as in all hybrid drives in which the internal combustion engine is driven by one or more electric motors regardless of the speed of the vehicle, i.e., also in serial and power-split hybrid drives.

1-22. (canceled)

23. A method for adapting an internal combustion engine which is situated in a hybrid vehicle and forms a drive unit with at least one secondary machine, the method comprising:
applying one of a positive or negative drive torque to the internal combustion engine by the secondary machine for setting at least one operating state of the internal combustion engine; and
determining at least one operating parameter of the internal combustion engine at the set operating state.

24. The method as recited in claim 23, wherein the secondary machine is an electric motor which applies a negative drive torque to the internal combustion engine running independently of the electric motor.

25. The method as recited in claim 24, wherein the adaptation at high loads of the internal combustion engine is performed during stationary operation of the hybrid vehicle, by applying a load to the internal combustion engine by the electric motor.

26. The method as recited in claim 24, wherein the adaptation is performed during driving operation of the hybrid vehicle, by the electric motor shifting the operating point of the internal combustion engine to a higher load by applying a negative drive torque in the case of an unchanged driver request torque.

27. The method as recited in claim 24, wherein the adaptation is performed during driving operation of the hybrid vehicle at a constant operating point of the internal combustion engine.

28. The method as recited in claim 24, wherein different load points are set by the electric motor as operating points of the internal combustion engine during stationary operation of the hybrid vehicle, and a driving operation state stored in the vehicle is retraced at every one of the different load points and an onboard diagnosis of the hybrid vehicle is performed.

29. The method as recited in claim 28, wherein an exact operating window for a mixture and air charge adaptation is set at each one of the different load points at a higher load.

30. The method as recited in claim 28, wherein at least one misfire rate of a cylinder of the internal combustion engine is determined at each one of the different load points at a higher load.

31. The method as recited in claim 30, wherein a torque characteristic curve plotted against the speed is provided for the electric motor, and wherein the electric motor runs through the entire torque characteristic curve plotted against the speed, an ignition error being inferred at a decreasing misfire rate ascertained when plotted against the load of the internal combustion engine, and a fuel injection error being inferred in the case of a constant misfire rate plotted against the load.

32. The method as recited in claim 24, wherein the speed of the electric motor is increased for leakage testing of a turbocharger system of the drive unit when the drive torque of the electric motor is greater than the drive torque of the internal combustion engine driven by the electric motor, and wherein a supercharging pressure characteristic curve recorded during the speed increase of the electric motor is compared to a setpoint characteristic curve.

33. The method as recited in claim 24, wherein different speeds of the internal combustion engine are set by the electric motor as operating points for an air system diagnosis with an open throttle valve, and one of a measured or calculated air mass flow is compared to reference air mass flow.

34. The method as recited in claim 23, wherein the secondary machine is an electric motor which alternately applies a positive and a negative drive torque to the internal combustion engine.

35. The method as recited in claim 34, wherein in the case of a fixedly set speed is the set operating point of the internal combustion engine, an actual relative air mass in the cylinders of the internal combustion engine is determined and compared to a predefined relative air mass, and the actual relative air mass is corrected by an air charge correction factor.

36. The method as recited in claim 35, wherein:
the electric motor applies a positive drive torque to the internal combustion engine when the internal combustion engine does not generate a drive torque, and the positive drive torque of the electric motor is measured;
subsequently the electric motor applies a negative drive torque at the same operating point of the internal combustion engine to the independently running internal combustion engine, and the negative drive torque of the electric motor is measured; and
the drive torque indicated by the internal combustion engine is ascertained from the measured negative drive torque and the measured positive drive torque of the electric motor, and the actual relative air mass is determined based on the ascertained drive torque indicated by the internal combustion engine, with the aid of a characteristic map.

37. The method as recited in claim 23, wherein the secondary machine is an electric motor which applies a positive drive torque to the internal combustion engine when the internal combustion engine does not generate a drive torque.

38. The method as recited in claim 37, wherein:
the electric motor mechanically cranks the internal combustion engine for a compression test of the cylinders of the internal combustion engine and the air in the cylinders is compressed without an injection of a fuel;
a signal of a crankshaft moved by the cylinders is measured;
an error in the compression of the cylinders is inferred in the case of a minimally fluctuating crankshaft signal; and
the compression of the cylinders is considered to be error-free in the case of a significantly fluctuating crankshaft signal.

39. The method as recited in claim 37, wherein the positive drive torque applied by the electric motor to the internal combustion engine during a supercharging pressure test is increased by increasing the speed of the electric motor, and a supercharging pressure characteristic curve of the turbocharger system is recorded and compared to a predefined setpoint characteristic curve.

40. The method as recited in claim 39, wherein the supercharging pressure curve is analyzed as plotted against the speed of the electric motor.

41. The method as recited in claim 37, wherein the electric motor at a constant low speed applies the positive drive torque to the internal combustion engine for a measurement of the air mass flow rate in an exhaust-gas recirculation, an exhaust-gas recirculation valve being opened incrementally with the throttle valve substantially closed, and the air mass flow rate in the intake manifold situated downstream from the throttle valve being evaluated.

42. The method as recited in claim 37, wherein the electric motor at a continuously changing speed transfers the positive drive torque to the internal combustion engine for diagnosing the air system with an open throttle valve, and a reference air mass flow is compared to one of a measured or calculated air mass flow.

43. The method as recited in claim 37, wherein a friction torque diagnosis of at least one cylinder is performed by (i) measuring the positive drive torque which is transferred by the electric motor to the internal combustion engine, and (ii) inferring an excessive friction torque in the cylinder of the internal combustion engine when a predefined positive drive torque is exceeded.

44. A device for adapting an internal combustion engine which is situated in a hybrid vehicle and forms a drive unit with at least one secondary machine, the device comprising:
means for controlling application of one of a positive or negative drive torque to the internal combustion engine by the secondary machine for setting at least one operating state of the internal combustion engine; and
means for determining at least one operating parameter of the internal combustion engine at the set operating state.
